(19) United States
(12) Patent Application Publication
(10) Pub. No.: US 2008/0095399 A1
(43) Pub. Date: Apr. 24, 2008

(54) Device and method for detecting occlusion area

(75) Inventors: Feng Cui, Suwon-si (KR); Jong-sul Min, Hwaseong-si (KR); Oh-jae Kwon, Anyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/783,989

(22) Filed: Apr. 13, 2007

(30) Foreign Application Priority Data
Oct. 23, 2006 (KR) 10-2006-0103090

(51) Int. Cl. G06K 9/00

(52) U.S. Cl. 382/103

(57) ABSTRACT

A device and method are provided for detecting an occlusion area in stages, which conducts a first stage of detection by detecting the occlusion type of the block based on a determination that the block is a covered area block or an uncovered area block, and conducts a second stage of detection by detecting whether each block detected at the first stage is an object block or a background block, so that an occlusion area can be accurately detected.

### CROSS-REFERENCE TO RELATED APPLICATIONS

This application claims the benefit under 35 U.S.C. §119 (a) of Korean Patent Application No. 10-2006-0103090, filed Oct. 23, 2006, in the Korean Intellectual Property Office, the entire disclosure of which is incorporated herein by reference.

### BACKGROUND OF THE INVENTION

1. Field of the Invention

The present invention relates to a device and method for detecting an occlusion area. More particularly, the present invention relates to a device and method for detecting an occlusion area in stages, which conducts a first stage of detection by detecting the occlusion type of a block based on a determination that the block is a covered area block or an uncovered area block, and which conducts a second stage of detection by detecting whether each block detected at the first stage is an object block or a background block, so that an occlusion area can be accurately detected.

2. Description of the Related Art

Generally, frame rate conversion (FRC) is used to generate interpolation frames between original frames using motion estimation and motion compensation techniques, and temporarily increases the resolution of the image, to eliminate motion blur.

In the FRC, a block-matching algorithm (BMA) is generally used for the motion estimation. The BMA compares two consecutive frames by block units and estimates one motion vector per block. The motion vector is estimated mainly using the sum of absolute differences (SAD) of the pixel values of the two frames.

However, in an occlusion area where the background and the object move differently in the frames, the motion vector is estimated inaccurately because image information exists in only one frame. FIGS. 1A and 1B illustrate an example of an occlusion area.

FIG. 1A shows an object moving from a previous frame N-1 to a current frame N, and FIG. 1B is a graphical representation of a frame which shows the object movement. Area 1 indicates an uncovered area of the occlusion area, that is, an area which has become uncovered, area 3 indicates a covered area of the occlusion area, that is, an area which has become covered, and area 2 indicates a portion where there is no change of coverage. Area 1, viz., the uncovered area was covered in the previous frame N-1 but has been uncovered in the current frame N. Area 3, viz., the covered area was uncovered in the previous frame N-1 but has been covered in the current frame N. Accordingly, areas 1 and 3 comprise information data for the motion vector estimation on only one side of either the current frame N or the previous frame N-1, and therefore, the motion vectors of areas 1 and 3 are inaccurately estimated.

Additionally, in order to estimate an accurate motion vector of the uncovered area or the covered area, it is necessary to detect the part of the occluding image that corresponds to the uncovered area and the covered area. Accordingly, it is not only necessary to detect the occlusion type of the blocks, but also detect whether the detected occlusion type is an object or a background.

Accordingly, a need exists for a device and method for effectively and efficiently detecting an occlusion area.

### SUMMARY OF THE INVENTION

Exemplary embodiments of the present invention have been provided to address at least the above problems and/or disadvantages, and to provide at least the advantages described below. Accordingly, an exemplary aspect of embodiments of the present invention is to provide a device and method for detecting an occlusion area in stages, which conducts a first stage of detection by detecting the occlusion type of the block based on a determination that the block is a covered area block or an uncovered area block, and conducts a second stage of detection by detecting whether each block detected at the first stage is an object block or a background block, so that an occlusion area can be accurately detected.

In order to achieve the above-described and other aspects of the present invention, a device for detecting an occlusion area is provided, which comprises a motion estimator for dividing a frame into a predetermined number of blocks, estimating one or more candidate motion vectors for each block, and determining a motion vector of the block from among the candidate motion vectors. The device further comprises a first occlusion detector for detecting the occlusion type of the blocks according to whether the block is a covered area block or an uncovered area block using the motion vector of the block, an occlusion reducer for eliminating a covered area block or an uncovered area block which is irregularly represented among the blocks after the occlusion type of the blocks is detected by the first occlusion detector, and a second occlusion detector for detecting whether each block output from the occlusion reducer is an object block or a background block.

The device can further comprise an occlusion recovery unit for determining whether a block is an object block or a background block according to a detection result of peripheral blocks adjacent to the block, if the block is not detected as an object block or a background block by the second occlusion detector.

Additionally, the motion estimator can generate an object flag, using the sum of absolute differences (SAD) of the blocks computed from a predetermined candidate motion vector among the plurality of candidate motion vectors for each block, and the determined motion vector of each block.

The first occlusion detector can detect the occlusion type of the blocks using a difference in average motion vectors between the right and left sides of a matrix comprising the predetermined number of blocks and the motion vector determined by the motion estimator.

The second occlusion detector can detect whether a current block is an object block or a background block using a direction of a motion vector of a discontinuous edge between blocks of the occlusion area.

Additionally, the second occlusion detector can detect whether the current block is an object block or a background block by referring to motion vectors of predetermined blocks of a previous line which are stored in an object line memory or a background line memory of the covered area, if the occlusion type of the current block is a covered area.

The second occlusion detector can determine that the current block is an object block, if both a first row including the current block of the matrix comprising the predetermined number of blocks and a second row of peripheral blocks adjacent to the first row comprise covered area blocks, if the occlusion type of the current block is a covered area.

Additionally, the second occlusion detector can determine that the current block is an object block, if a first row including the current block of the matrix comprising the predetermined number of blocks is an object flag and a second row of peripheral blocks adjacent to the first row is not an object flag.

The second occlusion detector can compare the motion vector of the current block to a line average motion vector of a current frame containing the current block to detect whether the current block is an object block or a background block.

The second occlusion detector can determine whether the current block is an object block or a background block by referring to motion vectors of predetermined blocks of a previous line which are stored in an object line memory or a background line memory of the uncovered area, if the occlusion type of the current block is an uncovered area.

Moreover, the second occlusion detector can determine whether the current block is an object block or a background block using the sum of absolute differences (SAD) of predetermined blocks computed from the determined motion vector of the current block and a line candidate motion vector of predetermined blocks, if the occlusion type of the current block is an uncovered area.

### BRIEF DESCRIPTION OF THE DRAWINGS

The above and other aspects and features of the present invention will become more apparent by describing certain exemplary embodiments of the present invention with reference to the accompanying drawings, in which:

FIGS. 1A and 1B are views illustrating a target occlusion area of detection according to exemplary embodiments of the present invention;

FIG. 2 is a block diagram illustrating a device for detecting an occlusion area according to an exemplary embodiment of the present invention;

FIGS. 3A and 3B are views illustrating a matrix comprising blocks used in the detection of the occlusion area according to exemplary embodiments of the present invention;

FIGS. 4A and 4B are views illustrating motion vector orientation of a discontinuous edge according to an exemplary embodiment of the present invention;

FIG. 5 is a view illustrating a line memory used in the detection of the occlusion area according to an exemplary embodiment of the present invention;

FIG. 6 is a view illustrating a matrix used in the detection of the occlusion area according to an exemplary embodiment of the present invention;

FIG. 7 is a view illustrating a current frame comprising a line average motion vector used in the detection of the occlusion area according to an exemplary embodiment of the present invention;

FIG. 8 is a view illustrating a detection result of a device for detecting an occlusion area according to an exemplary embodiment of the present invention; and

FIG. 9 is a flowchart illustrating operations for detecting an occlusion area according to exemplary embodiments of the present invention.

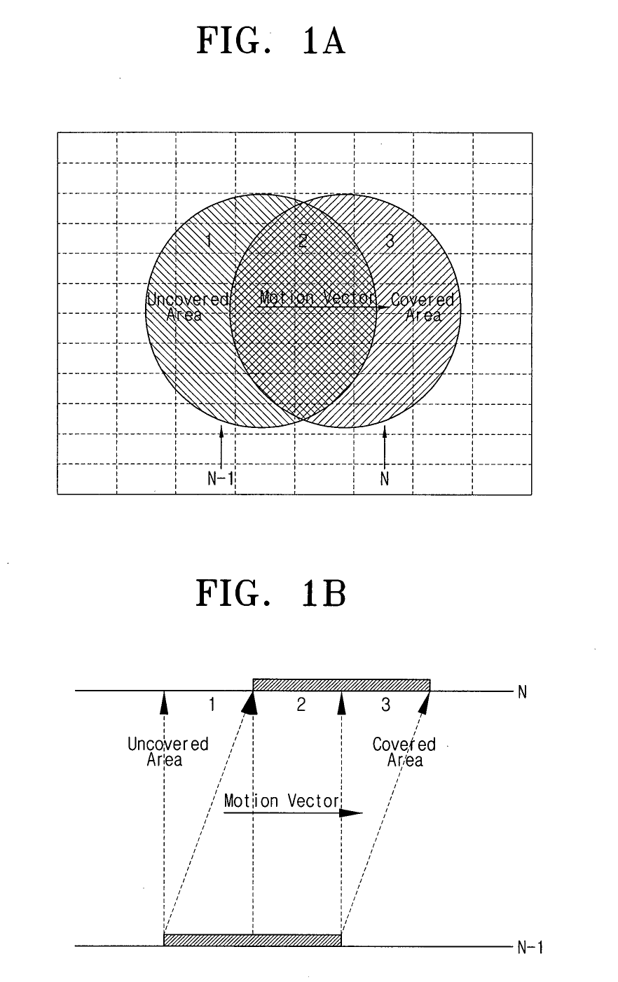

Throughout the drawings, the same drawing reference numerals will be understood to refer to the same elements, features and structures.

### DETAILED DESCRIPTION OF EXEMPLARY EMBODIMENTS

Certain exemplary embodiments of the present invention will now be described in greater detail with reference to the accompanying drawings.

The matters defined in the description, such as a detailed constructions and elements, are provided to assist in a comprehensive understanding of the embodiments of the present invention and are merely exemplary. Accordingly, those of ordinary skill in the art will recognize that various changes and modifications of the exemplary embodiments described herein can be made without departing from the scope and spirit of the present invention. Also, descriptions of well-known functions and constructions are omitted for clarity and conciseness.

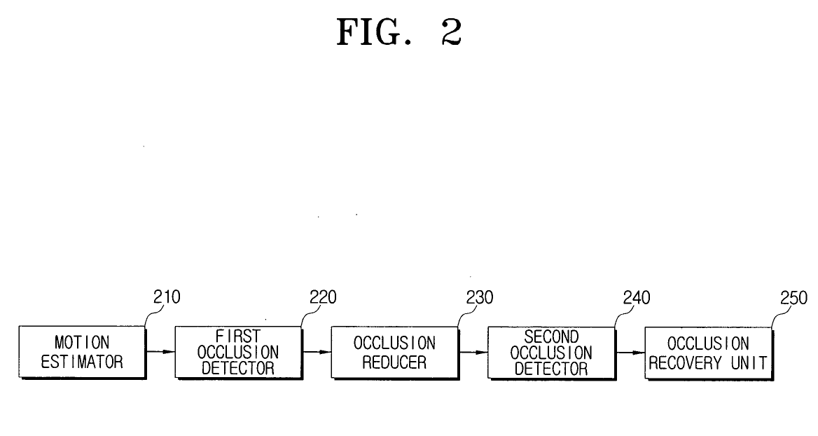

FIG. 2 is a block diagram illustrating a device for detecting an occlusion area according to an exemplary embodiment of the present invention.

A device for detecting an occlusion area according to an exemplary embodiment of the present invention comprises a motion estimator 210, a first occlusion detector 220, an occlusion reducer 230, a second occlusion detector 240, and an occlusion recovery unit 250.

The motion estimator 210 divides a current frame into a predetermined number of blocks, estimates one or more candidate motion vectors for each of the blocks, and determines a motion vector of the block from among the candidate motion vectors. The candidate motion vectors can be obtained by a variety of detection ranges and methods, and can include full search motion vectors, line candidate motion vectors, average candidate motion vectors, zero candidate motion vectors, and so forth. The line candidate motion vectors are obtained from the average of non-zero motion vectors of a previous frame in the same horizontal line of the current block. Among the plurality of candidate motion vectors obtained above, a motion vector of each block is determined based on the sum of absolute differences (SAD) or other information.

Additionally, the motion estimator 210 generates an object flag, using SAD of the blocks computed from a certain candidate motion vector of the plurality of candidate motion vectors, and the motion vector of each block. The object flag is set as satisfying the following Equation (1) below,

SADₗᵢₙₑ(m, n)>LINESAD_THRESH

SADₗᵢₙₑ(m, n)−SAD_{final}(m, n)|>SADDIFF_THRESH (Equation1)

wherein, SADₗᵢₙₑ(m, n) is a SAD of the line candidate motion vector of the current block (m, n), and SAD_{final}(m, n) is a SAD of the current block (m, n) computed from the motion vector which is determined to be the most appropriate among the plurality of the candidate motion vectors. Additionally, LINESAD_THRESH is a positive threshold of the line candidate motion vectors, and SADDIFF_THRESH is a positive threshold of the difference between the SAD.

The first occlusion detector 220 detects the occlusion type of the blocks, that is, determines whether each block is a covered area block or an uncovered area block, according to a predetermined condition using the motion vector of each block.

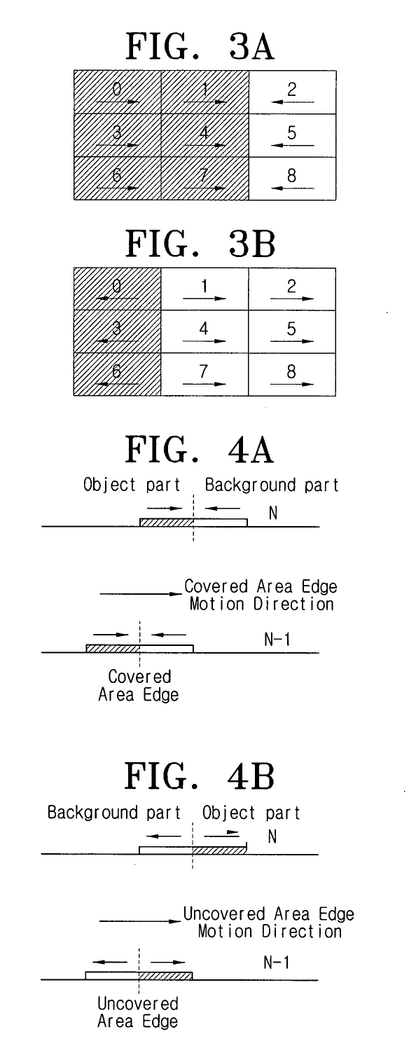

Referring to FIGS. 3A and 3B, a 3×3 matrix is illustrated, which includes a current block 4 (m, n), and the peripheral blocks 0, 1, 2, 3, 5, 6, 7 and 8 surrounding the current block 4. In order to detect the occlusion type of the blocks, blocks 0, 3 and 6, and blocks 2, 5 and 8 at the left and right rows of the matrix are designated as edge blocks, and an average of the motion vector is computed. The average motion vector can be computed with reference to the right-hand edge blocks, as illustrated in FIG. 3A, and to the left-hand edge blocks, as illustrated in FIG. 3B. If the blocks are divided on the basis of the left-hand edge blocks, an MVmean_right value includes blocks 1, 2, 4, 5, 7 and 8. If the blocks are divided on the basis of the right-hand edge blocks, an MVmean_left value includes blocks 0, 1, 3, 4, 6 and 7. As described above, blocks are divided and then the average motion vector is computed, because the occlusion area generally contains an edge which is formed as a boundary line having a discontinuous motion between the current block and peripheral blocks. The average motion vector of the blocks is computed using the following Equation (2) below,

$${MV}_{mean\_left} = \frac{\begin{matrix}\begin{matrix}{w}_{0} \times Bmv [ 0 ] + {w}_{1} \times Bmv [ 1 ] + \\ {w}_{3} \times Bmv [ 3 ] + {w}_{4} \times Bmv [ 4 ] +\end{matrix} \\ {w}_{6} \times Bmv [ 6 ] + {w}_{7} \times Bmv [ 7 ]\end{matrix}}{{w}_{0} + {w}_{1} + {w}_{3} + {w}_{4} + {w}_{6} + {w}_{7}} \\ {MV}_{mean\_right} = \frac{\begin{matrix}\begin{matrix}{w}_{1} \times Bmv [ 1 ] + {w}_{2} \times Bmv [ 2 ] + \\ {w}_{4} \times Bmv [ 4 ] + {w}_{5} \times Bmv [ 5 ] +\end{matrix} \\ {w}_{7} \times Bmv [ 7 ] + {w}_{8} \times Bmv [ 8 ]\end{matrix}}{{w}_{1} + {w}_{2} + {w}_{4} + {w}_{5} + {w}_{7} + {w}_{8}} \\ {MV}_{edge\_left} = \frac{\begin{matrix}{w}_{0} \times Bmv [ 0 ] + {w}_{3} \times Bmv [ 3 ] + \\ {w}_{6} \times Bmv [ 6 ]\end{matrix}}{{w}_{0} + {w}_{3} + {w}_{6}} \\ {MV}_{edge\_right} = \frac{\begin{matrix}{w}_{2} \times Bmv [ 2 ] + {w}_{5} \times Bmv [ 5 ] + \\ {w}_{8} \times Bmv [ 8 ]\end{matrix}}{{w}_{2} + {w}_{5} + {w}_{8}} \qquad ( Equation 2 )$$

wherein, W₀, . . . , W₈ are weighted values.

The direction of the motion of the current block is predicted based on the average motion vector as computed above. If the six motion vectors in the left side of the matrix, including the current block, with reference to the MVmean_left value have a degree of distribution below a predetermined threshold, it is determined that the current block has a left-bound motion. If the six motion vectors in the right side of the matrix, including the current block, with reference to the MVmean_right value have a degree of distribution below a predetermined threshold, it is determined that the current block has a right-bound motion. The current block can have either left-bound or right-bound motions, at least within the occlusion area.

If the current block has a left-bound direction and meets condition (1) of Equation (3) below, the block is determined to be a covered area block. If the current block has a left-bound direction and meets condition (2) of Equation (3) below, the block is determined to be an uncovered area block.

(1) MVₘₑₐₙ_{_{—}}_{left}−MV_{edge}_{_{—}}_{right}>MVDIFF_THRESH

(2) MVₘₑₐₙ_{_{—}}_{left}−MV_{edge}_{_{—}}_{right}<−MVDIFF_THRESH (Equation 3)

If the current block has a right-bound direction and meets condition (3) of Equation (4) below, the block is determined to be a covered area block. If the current block has a right-bound direction and meets condition (4) of Equation (4) below, the block is determined to be an uncovered area block,

(3) MVₘₑₐₙ_{_{—}}_{right}−MV_{edge}_{_{—}}_{left}>MVDIFF_THRESH

(4) MVₘₑₐₙ_{_{—}}_{right}−MV_{edge}_{_{—}}_{left}<−MVDIFF_THRESH (Equation 4)

wherein, MVDIFF_THRESH is a predetermined threshold.

The occlusion reducer 230 eliminates a covered area block or an uncovered area block which is irregularly represented, among the blocks detected at the first occlusion detector 220. The occlusions which are irregularly represented at a distance from the covered area blocks or the uncovered area blocks after the detection of the occlusion type by the first occlusion detector 220, are regarded as detection errors, and accordingly, are removed. The output from the occlusion reducer 230 is then transmitted to the second occlusion detector 240, and is also stored in order to be used in the analysis of the next frame following the current frame at the second occlusion detector 240.

The second occlusion detector 240 detects whether each block output from the occlusion reducer 230 is an object block or a background block. As the occlusion type of the blocks, that is, whether each of the blocks is a covered area block or an uncovered area block, has been determined as described above, the following exemplary embodiment will be explained using, for example, an assumption that each block output from the first occlusion detector 220 and the occlusion reducer 230 is a covered area block.

In a first exemplary method, the second occlusion detector 240 detects whether the current block is an object block or a background block using the motion vector of the discontinuous edge between blocks of the occlusion area. If the current block is an occlusion area block, there is an edge which contains the discontinuous motion vectors between the current block and peripheral blocks adjacent to the current block.

FIG. 4A shows the current block being a covered area, and having an edge containing the discontinuous motion vectors between the object and background. When comparing the previous frame with the current frame, it indicates that the edge is moving to the right and has a rightward motion vector. At this time, as described above, information pertaining to the previous frame is used, that is, the output from the occlusion reducer 230, stored before the current frame is processed. If the motion vector of the current block is similar to that of the edge, the current block is determined to be an object block. However, if the motion vector of the current block is not similar to that of the edge, the current block may be other than the object block. In this case, the current block is determined to be an object or a background according to the respective motion vectors of the current block and the peripheral blocks adjacent to the current block.

In a second exemplary method, if the current block is not detected as an object or a background using the above method, a line memory can be used. In the device for detecting an occlusion area according to an exemplary embodiment of the present invention, four line memories are used, such as an object line memory and a background line memory for the covered area, and an object line memory and a background line memory for the uncovered area, but is not limited thereto. Each line memory stores a result of detecting an occlusion area of a line prior to the current block.

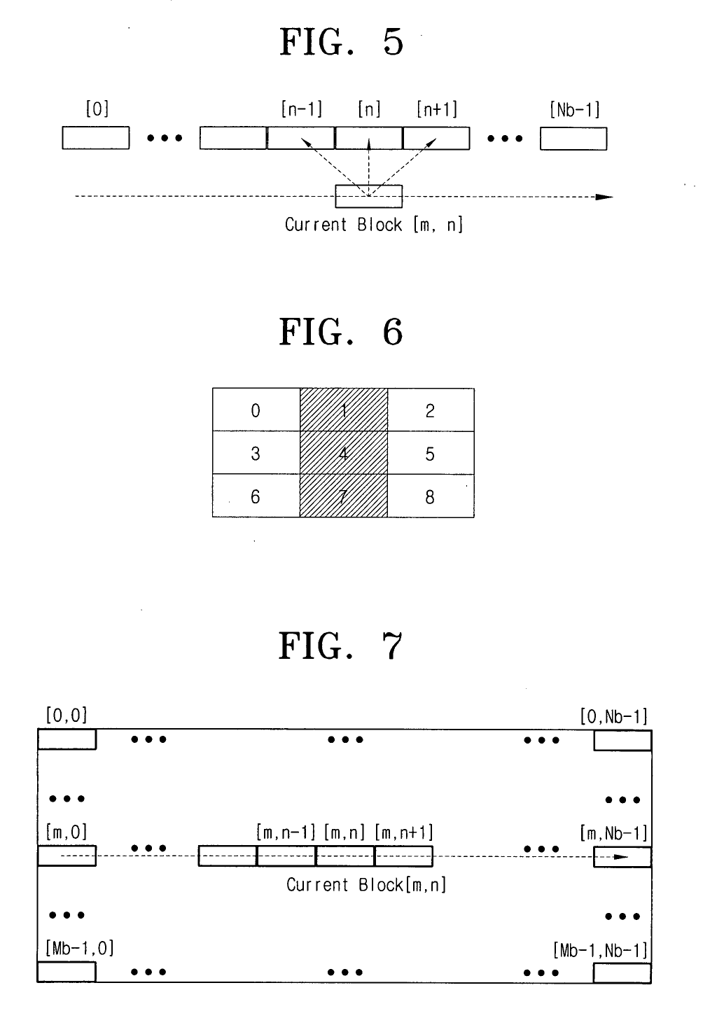

For example, if the occlusion area is an object of the covered area, it is stored in the object line memory of the covered area. Since the system processes each block line by line, the line memory is updated after all of the blocks of a line prior to the horizontal line containing the current block are processed by the second occlusion detector. FIG. 5 is a view illustrating each block of an exemplary line memory. If any one from among (n−1), (n), and (n+1) blocks of the line memory is similar to the motion vector of the current block (m, n), it is determined to have a motion vector according to the type of the corresponding line memory. For example, if the motion vector of the current block (m, n) is similar to that of any one from among (n−1), (n), and (n+1) blocks of the object line memory of the covered area, the current block is determined to be the object block of the covered area.

In a third exemplary method, if the current block has still not been detected as an object or a background using the above methods, the occlusion area of the current block can be detected as follows. A matrix is constructed using a predetermined number of blocks as shown in FIG. 6. A row (illustrated via the hashed portion) including the current block 4 of the matrix comprises the covered area blocks. If the discontinuous peripheral blocks 0, 3, 6 or 2, 5 and 8, indicate the uncovered area blocks, the current block is determined to be the object block. This method is not applied in the situation where the current block is an uncovered area block.

In a fourth exemplary method, if the current block has still not been detected as an object or a background using the above methods, the occlusion area of the current block can be detected as follows. An object flag generated by the motion estimator 210 is used, and the determination method is performed in substantially the same manner as in the above third exemplary method. That is, a matrix is constructed with a predetermined number of blocks, and a row (illustrated via the hashed portion) including the current block 4 of the matrix comprises the object flag. If the discontinuous peripheral blocks 0, 3, 6 or 2, 5 and 8, are not the object flags, the current block is determined to be an object block.

In a fifth exemplary method, if the current block still has not been detected as an object or a background using the above methods, the occlusion area of the current block can be detected as follows. The motion vector of the current block is compared to the line average motion vector of the current frame containing the current block, to detect whether the current block is an object block or a background block. In most images, a background motion vector is similar to the line average motion vector. The line average motion vector indicates the average of the motion vectors of the horizontal line of the current frame containing the current block. FIG. 7 illustrates the current block (m, n), and the horizontal line of the current frame containing the current block (m, n). Accordingly, if the motion vector of the current block is similar to the line average motion vector, the current block is determined to be a background block.

Hereinafter, an exemplary situation is described in which each block output from the first occlusion detector 220 and occlusion reducer 230 is an uncovered area. The second occlusion detector 240 performs the following methods in stages in substantially the same manner as in the method for detecting an object and a background in the covered area.

The second occlusion detector 240 first detects whether the current block is an object block or a background block using a motion vector of a discontinuous edge between blocks of the occlusion area (see FIG. 4B). FIG. 4B shows the current block being an uncovered area, and having an edge containing the discontinuous motion vectors between the object and background. When comparing the previous frame with the current frame, it indicates that the edge is moving to the right and has a rightward motion vector. The occlusion area of the current block is detected in substantially the same manner as in the above first exemplary method, and accordingly, additional descriptions thereof are omitted.

If the current block is not detected as an object block or a background block using the above method, a line memory can be used. Accordingly, if the current block is an uncovered area, the occlusion area of the current block is detected using the object and background line memories for the uncovered area. This method is performed in substantially the same manner as in the above second exemplary method, and accordingly, additional descriptions thereof are omitted.

Next, if the current block still has not been detected as an object block or a background block using the above methods, an object flag generated by the motion estimator 210 is used. This method is performed in substantially the same manner as in the above fourth exemplary method, and accordingly, additional descriptions thereof are omitted.

If the current block still has not been detected ass an object block or a background block using the above methods, the second occlusion detector 240 determines whether the current block is an object block or a background block using the SAD of the predetermined blocks computed from the determined motion vector of the current block and the line candidate motion vector. The SAD of the background block in the uncovered area is generally higher than that of the corresponding object block. This is because it is impossible to find the portion corresponding to the background block in the previous frame. Therefore, the current block (m, n) is the object block in the uncovered area when satisfying the following Equation (5) below.

SAD_{final}(m, n)<FINALSAD_THRESH,

SAD_{final}(m, n+1)−SAD_{final}(m, n)>SADDIFF_THRESH: (Equation 5)

when the current block (m, n) is a leftward motion vector,

SADₗᵢₙₑ(m, n+1)>LSAD_THRESH:

when the current block (m, n) is a leftward motion vector,

SAD_{final}(m, n−1)−SAD_{final}(m, n)>SADDIFF_THRESH:

when the current block (m, n) is a rightward motion vector, and

SADₗᵢₙₑ(m, n−1)>LSAD_THRESH:

when the current block (m, n) is a rightward motion vector,
wherein, FINALSAD_THRESH, SADDIFF_THRESH, and LSAD_THRESH are predetermined thresholds.

Finally, if the current block still has not been detected as an object block or a background block using the above methods, the motion vector of the current block is compared to the line average motion vector of the current frame containing the current block, to detect whether the current block is an object block or a background block. This method is performed in substantially the same manner as in the above fifth exemplary method, and accordingly, additional descriptions thereof are omitted.

Even though the above methods are used in the second occlusion detector, the current block may still not be detected as an object block or a background block. In this case, the occlusion recovery unit 250 can determine whether the block is an object block or a background block according to the detection result of the peripheral blocks. For example, if it is not yet detected whether some blocks irregularly represented among the object blocks are object blocks or background blocks, this block may be designated as the object block.

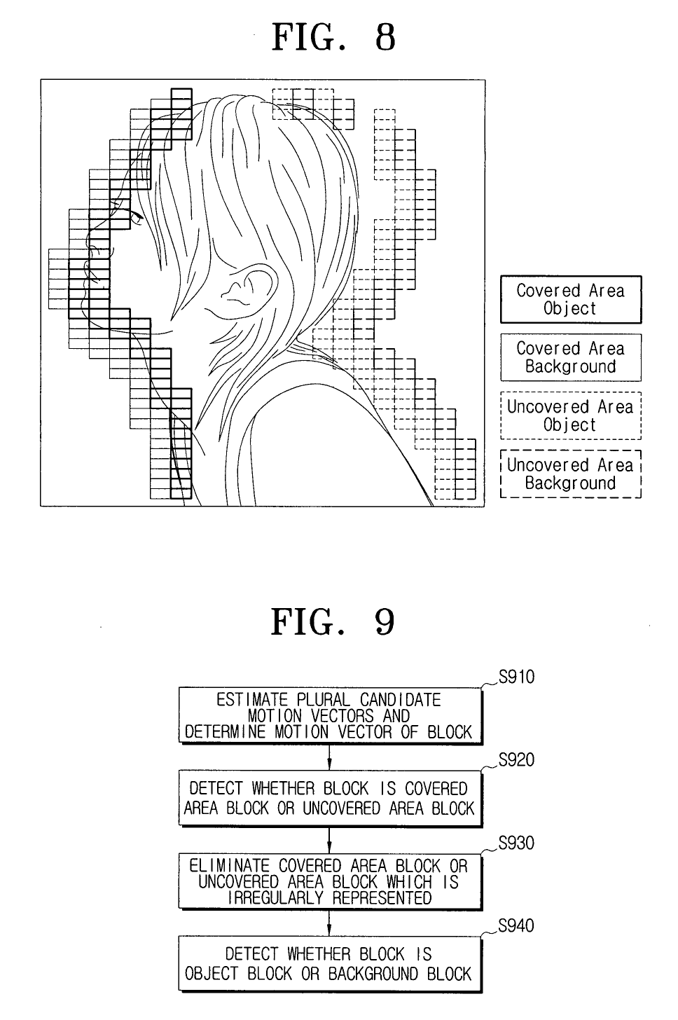

FIG. 8 is a view illustrating a result of detecting the occlusion type of the blocks by the device for detecting an occlusion area. FIG. 8 is an image made up of blocks defined as illustrated by the borders of each. The blocks are shown to the left as covered area objects and covered area backgrounds, and shown to the right as uncovered area objects and uncovered area backgrounds. It can be seen that the covered area block is mainly represented in a moving direction of the object (person), and the uncovered area block is represented in the back of the object (person).

FIG. 9 is a flowchart illustrating a method for detecting the occlusion area according to exemplary embodiments of the present invention.

The current frame is first divided into a predetermined number of blocks, a plurality of candidate motion vectors are estimated by block units, and then a motion vector of each block among the plurality of candidate motion vectors is determined in operation S910. Next, the occlusion type of the blocks, that is, whether each block is a covered area block or an uncovered area block, is detected using the motion vector of each block in operation S920. Thereafter, a covered area block or an uncovered area block which is irregularly represented, among the blocks after the occlusion type of the blocks is detected, is eliminated in operation S930. In operation S940, it is detected whether each block output after the elimination is an object block or a background block.

The exemplary embodiments of the present invention provide a device and method for detecting an occlusion area in stages, which conducts a first stage of detection by detecting the occlusion type of the block based on a determination that the block is a covered area block or an uncovered area block, and conducts a second stage of detection by detecting whether each block detected at the first stage is an object block or a background block, so that an occlusion area can be accurately detected.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A device for detecting an occlusion area, comprising:
a motion estimator for dividing a frame into a predetermined number of blocks, estimating one or more candidate motion vectors for each block, and determining a motion vector of the block from among the candidate motion vectors;
a first occlusion detector for detecting the occlusion type of the blocks according to whether the block is a covered area block or an uncovered area block using the motion vector of the block;
an occlusion reducer for eliminating a covered area block or an uncovered area block, which is irregularly represented, among the blocks after the occlusion type of the blocks is detected by the first occlusion detector; and
a second occlusion detector for detecting whether each block output from the occlusion reducer is an object block or a background block.

2. The device as claimed in claim 1, further comprising an occlusion recovery unit for determining whether a block is an object block or a background block according to a detection result of peripheral blocks adjacent to the block, if the block is not detected as an object block or a background block by the second occlusion detector.

3. The device as claimed in claim 1, wherein the motion estimator is configured to generate an object flag, using the sum of absolute differences (SAD) of the blocks computed from a predetermined candidate motion vector among the plurality of candidate motion vectors for each block, and the determined motion vector of each block.

4. The device as claimed in claim 1, wherein the first occlusion detector is configured to detect the occlusion type of the blocks using a difference in average motion vectors between the right and left sides of a matrix comprising the predetermined number of blocks and the motion vector determined by the motion estimator.

5. The device as claimed in claim 1, wherein the second occlusion detector is configured to detect whether a current block is an object block or a background block using a direction of a motion vector of a discontinuous edge between blocks of the occlusion area.

6. The device as claimed in claim 1, wherein the second occlusion detector is configured to detect whether the current block is an object block or a background block by referring to motion vectors of predetermined blocks of a previous line which are stored in an object line memory or a background line memory of the covered area, if the occlusion type of the current block is the covered area.

7. The device as claimed in claim 1, wherein the second occlusion detector is configured to determine that the current block is an object block if both a first row including the current block of the matrix comprising the predetermined number of blocks and a second row of peripheral blocks adjacent to the first row comprise covered area blocks, if the occlusion type of the current block is the covered area.

8. The device as claimed in claim 1, wherein the second occlusion detector is configured to determine that the current block is an object block if a first row including the current block of the matrix comprising the predetermined number of blocks is an object flag and a second row of peripheral blocks adjacent to the first row is not an object flag.

9. The device as claimed in claim 1, wherein the second occlusion detector is configured to compare the motion vector of the current block to a line average motion vector of a current frame containing the current block to detect whether the current block is an object block or a background block.

10. The device as claimed in claim 1, wherein the second occlusion detector is configured to determine whether the current block is an object block or a background block by referring to motion vectors of predetermined blocks of a previous line which are stored in an object line memory or a background line memory of the uncovered area, if the occlusion type of the current block is the uncovered area.

11. The device as claimed in claim 1, wherein the second occlusion detector is configured to determine whether the current block is an object block or a background block using the sum of absolute differences (SAD) of predetermined blocks computed from the determined motion vector of the current block and a line candidate motion vector, if the occlusion type of the current block is the uncovered area.

12. A method for detecting an occlusion area, comprising:
(a) dividing a frame into a predetermined number of blocks, estimating one or more candidate motion vectors for each block unit and determining a motion vector of the block from among the candidate motion vectors;
(b) detecting an occlusion type of the blocks, by determining whether the block is a covered area block or an uncovered area block using the motion vector of the block;
(c) eliminating a covered area block or an uncovered area block which is irregularly represented among the blocks after the occlusion type of the blocks is detected; and
(d) detecting whether each block output from the step (c) is an object block or a background block.

13. The method as claimed in claim 12, further comprising determining whether a block is an object block or a background block according to a detection result of peripheral blocks of the block, if the block is not determined to be an object block or a background block in the step (d).

14. The method as claimed in claim 12, wherein the step (a) comprises generating an object flag, using the sum of absolute differences (SAD) of the blocks computed from a predetermined candidate motion vector among the plurality of candidate motion vectors for each block, and the determined motion vector of each block.

15. The method as claimed in claim 12, wherein the step (b) comprises determining the occlusion type of the blocks using a difference in average motion vectors between the right and left sides of a matrix comprising the predetermined number of blocks and the motion vector determined by the motion estimator.

16. The method as claimed in claim 12, wherein the step (d) is performed using a direction of a motion vector of a discontinuous edge between blocks of the occlusion area.

17. The method as claimed in claim 12, wherein the step (d) comprises determining whether the current block is an object block or a background block by referring to motion vectors of predetermined blocks of a previous line which are stored in an object line memory or a background line memory of the covered area, if the occlusion type of the current block is the covered area.

18. The method as claimed in claim 12, wherein the step (d) comprises determining that the current block is an object block if both a first row including the current block of the matrix comprising the predetermined number of blocks and a second row of peripheral blocks adjacent to the first row comprise covered area blocks, if the occlusion type of the current block is the covered area.

19. The method as claimed in claim 12, wherein the step (d) comprises determining that the current block is an object block if a first row including the current block of the matrix comprising the predetermined number of blocks is an object flag and a second row of peripheral blocks adjacent to the first row is not an object flag.

20. The method as claimed in claim 12, wherein the step (d) comprises comparing the motion vector of the current block to a line average motion vector of a current frame containing the current block.

21. The method as claimed in claim 12, wherein the step (d) comprises determining whether the current block is an object block or a background block by referring to motion vectors of predetermined blocks of a previous line which are stored in an object line memory or a background line memory of the uncovered area, if the occlusion type of the current block is the uncovered area.

22. The method as claimed in claim 12, wherein the step (d) comprises determining whether the current block is an object block or a background block using the sum of absolute differences (SAD) of predetermined blocks computed from the determined motion vector of the current block and a line candidate motion vector, if the occlusion type of the current block is the uncovered area.
